(19) United States
(12) Patent Application Publication
(10) Pub. No.: US 2009/0211948 A1
(43) Pub. Date: Aug. 27, 2009

(54) METHOD AND DEVICE FOR SWITCHING OVER SHUT-OFF MEMBERS ON CRACKING FURNACES

(76) Inventor: Herbert MEIER, Martinsried (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/389,745

(22) Filed: Feb. 20, 2009

(30) Foreign Application Priority Data
Feb. 22, 2008 (DE) 10 2008 010 654.2

(51) Int. Cl. C10G 9/16; G05D 16/00

(52) U.S. Cl. 208/48 R; 422/112

(57) ABSTRACT

The invention relates to a method and also a device for switching over a cracking furnace between production mode and decoking mode, wherein a first shut-off member (TLV), which is arranged in the transfer line and equipped with a first actuating drive, and a second shut-off member (EGV), which is arranged in the decoking line and equipped with a second actuating drive, are actuated simultaneously and wherein the differential pressure DP across the shut-off member TLV is continuously measured and monitored. The actuation of the shut-off members TLV and EGV is carried out in an automated manner, wherein TLV is moved monotonously between its end positions, while the second actuating drive is triggered by the actuating signal of a control means and EGV is as a result actuated in such a way that DP is at all times approximated to a predefined target value (DP target).

### BACKGROUND OF THE INVENTION

The invention relates to a method for switching over a cracking furnace between production mode and decoking mode, wherein a first shut-off member (TLV), which is arranged in the transfer line and equipped with a first actuating drive, and a second shut-off member (EGV), which is arranged in the decoking line and equipped with a second actuating drive, are actuated simultaneously and wherein the differential pressure DP across the shut-off member TLV is continuously measured and monitored.

In addition, the invention relates to a device for carrying out the method.

The term “transfer line” denotes a pipeline via which the cracked gas produced during the production mode in a cracking furnace is drawn off and supplied to further treatment, for example in a gas separation means. Upstream of TLV, a pipeline, which is denoted as the “decoking line” and via which the decoking gas formed in the coking furnace is drawn off during the decoking mode, branches off from the transfer line. During the production mode, the decoking line is shut off by EGV, while TLV is completely open. In the decoking mode, EGV is completely open and TLV completely closed.

Cracking furnaces, externally fired tubular reactors, have been known for many years to persons skilled in the art and are used in industry for different purposes. Thus, they are, for example, used to produce olefins from high-boiling hydrocarbons and water vapor by thermal cracking.

The hydrocarbons are in this case heated together with the water vapor in the convection zone of the cracking furnace up to a temperature at which cracking of the hydrocarbons just starts (500-680° C., depending on the nature of the hydrocarbons). Subsequently, the hydrocarbons are passed in what are known as radiation tubes through the radiation zone of the cracking furnace, wherein they are cracked into smaller molecules under controlled conditions (residence time, temperature profile, partial pressures). In addition to the desired main products (for example, ethylene and propylene), other olefins and also further substances are formed. In order to prevent the reaction products from being broken down in secondary reactions, they are, following the radiation zone, which they leave at temperatures of between 800 and 850° C., cooled down to 550-650° C. in 0.02-0.1 s. The cracked gas produced in this way is forwarded via the transfer line in order to be cracked in complex steps for physical and chemical separation steps into the desired products.

The thermal cracking of the hydrocarbons inevitably produces carbon which is deposited as coke on the insides of the radiation tubes, where it forms a layer. The layer of coke prevents the conveyance of heat from the radiation tubes to the process gas flowing through them, increases the tube wall temperature and reduces the size of the free flow cross section in the radiation tubes, as a result of which the loss in pressure across the tubes increases. As a result of this, the operating costs rise and at the same time the yield of desired olefins falls. From time to time, it is therefore necessary to interrupt the mode of production of a cracking furnace of this type and to remove the coke depositions from the radiation tubes in what is known as decoking mode.

As mechanical methods cannot be used to eliminate the layer of coke, the radiation tubes are normally flushed through with a mixture of air and water vapor, whereby the coke is burnt off and thus conveyed out of the cracking furnace.

In order to switch over the cracking furnace from production mode into decoking mode, it is necessary to close a shut-off member (TLV) which is integrated into the transfer line and at the same time to open a shut-off member (EGV) which is integrated into the decoking line. Subsequently, a water vapor/air mixture is passed through the radiation tubes and the resulting substance mixture drawn off via the decoking line.

The switching-over between production mode and decoking mode must be carried out in such a way that a reflux of hydrocarbons via the TLV is prevented and the pressure at the exit of the cracking furnace does not exceed a maximum value. These conditions are met as a result of the fact that the opening and shutting of the two shut-off members, TLV and EGV, are performed essentially simultaneously while being adapted to each other. During a switching-over process, the differential pressure across the TLV is continuously monitored. In this case, the differential pressure in the normal flow direction is to be held, in phases of the switching-over process in which both shut-off members are not closed, at all times close to a safe value of approx. 1.00 bar. According to the prior art, the switching-over process is carried out by two to three operators who actuate both shut-off members by hand or via actuating drives to be operated on site and at the same time monitor the differential pressure across TLV. As human error can never be ruled out, the prior art often provides for the integration into the transfer line, to increase safety, of a check flap downstream of the TLV and of a safety relief valve upstream.

In order to reduce the risk of operating errors, solutions are also known from practical experience, in which TLV and EGV are mechanically connected to each other in such a way that both can be jointly actuated. However, the solutions have certain serious drawbacks:
In order to adhere to the necessary differential pressure, the flow quantitative range is greatly restricted, as the mechanical connection can compensate only to a very limited extent for quantitative differences in flow to establish safe operation.
Owing to a differing temperature response in the transfer and decoking line, high fluctuations occur in the forces and moments which act on the shut-off members and can lead to jamming of the mechanical drives and sealing elements of the shut-off members.
TLV and EGV have to be installed immediately next to one another, as a result of which it is difficult to embody the pipework for the process optimally and at low costs.
Independent actuation of TLV and EGV is possible only with difficulty.
The two shut-off members have to be obtained from the same supplier, and this restricts the freedom of selection.

### SUMMARY OF THE INVENTION

Thus, according to an aspect of the present invention there is provided a method of the type described above, and also a device for carrying out said method by means of which drawbacks of the prior art are overcome.

In terms of the method aspect of invention, actuation of the shut-off members TLV and EGV is carried out in an automated manner, wherein TLV is moved monotonously between its end positions, while the second actuating drive is triggered by the actuating signal of a control means and EGV is, as a result, actuated in such a way that DP (pressure differential across TLV) is at all times approximated to a predefined target value (DP target).

The method according to the invention is suitable for use with all cracking furnaces having a transfer line and a waste gas line. However, it is preferably used with cracking furnaces that are used to prepare olefins from feedstocks containing hydrocarbons.

One configuration of the method according to the invention provides for the measured value for DP to be converted into an electrical signal and supplied as the actual value (DP actual) to the control means, which is preferably embodied as an electrical PID controller and issues a continuous electrical actuating signal to the actuating drive of EGV on the basis of the comparison of DP actual with DP target.

Another configuration of the method according to the invention provides for DP to be monitored and controlled by means of two pressure switches, wherein one pressure switch issues a discrete electrical actuating signal to the actuating drive of EGV on DP exceeding an upper limit (DPO) and the other pressure switch does so on DP dropping below a lower limit (DPU). On DP exceeding of DPO, EGV is opened. Conversely, EGV is closed on DP dropping below the lower limit DPU.

Expediently, the two pressure switches allow the setting of overlapping switching ranges which follow downwardly DPO and upwardly DPU and in the overlap of which DP target lies. Beneficially, both switching ranges are set to a value which is less than the separation between DPO and DPU. If for example DPO is exceeded, an actuating signal for opening EGV is issued until DP has dropped to a value outside the switching range. The setting of switching ranges allows the number of switching cycles to be reduced and thus the stability of the control to be increased.

In practice, TLV and EGV are embodied as shut-off flaps or slides both having a non-linear throughflow characteristic; this makes use thereof in a control circuit problematic. The further the shut-off member is closed, the more marked the effect of changes in the position of a shut-off member of this type on the throughflow. In order to allow both shut-off members nevertheless reliably to perform their task as parts of a control circuit, a beneficial development of the method according to the invention provides for the two shut-off members TLV and EGV each to be displaced at at least two different speeds, wherein the extent of the displacement speed is dependent on the instantaneous position of the shut-off member. Expediently, each of the positions of a shut-off member in which a change in the displacement speed occurs (switch-over points) and also the displacement speeds can be changed and adapted to the control characteristic of the control circuit.

Even the standard versions of modern actuating drives allow a shut-off member to be displaced between the positions Open and Closed at more than one speed. Thus, if a shut-off member is to be closed, it can be displaced at the beginning of the closing process at the normal displacement speed, wherein it covers approx. 25 to 50% of the total displacement distance per minute. From a predefined switch-over point, the closing process is continued at a much lower second displacement speed up to the closed position. Typically, the second displacement speed is just 5 to 10% of the normal displacement speed. The change in the displacement speed can be obtained using a variable-speed actuating drive. Another possibility involves the use of a constant-speed actuating drive which is operated, to attain a reduced displacement speed, at short time intervals, each of which are followed by a much longer downtime. This procedure establishes an average displacement speed which can be much lower than the normal displacement speed.

The invention further relates to a device for switching over a cracking furnace between production mode and decoking mode, comprising: a first shut-off member (TLV) arranged in the transfer line, a second shut-off member (EGV) arranged in the decoking line, and also a differential pressure measuring means which can be used continuously to measure and to monitor the differential pressure DP across the shut-off member TLV, wherein the two shut-off members each have an actuating drive via which they can be displaced simultaneously.

In terms of the device aspect of the invention, there is provided a control means via which EGV can be displaced in such a way that DP is at all times approximated to a predefined target value (DP target), while TLV is moved monotonously between its end positions.

According to the invention, the cracking furnace is any desired cracking furnace, but preferably a cracking furnace which can be used to produce olefins from feedstocks containing hydrocarbons.

A preferred configuration of the device according to the invention provides for the control means to be an electric controller which is preferably embodied as a PID controller. The electric controller, to which the measured value for DP, which has been converted into an electrical signal, can be supplied as the actual value (DP actual), issues a continuous electrical actuating signal to the actuating drive of EGV on the basis of the comparison of DP actual with DP target.

Another preferred configuration of the device according to the invention provides for the control means to be embodied with two pressure switches, wherein one pressure switch issues a discrete electrical actuating signal to the actuating drive of EGV on exceeding an upper limit (DPO) and the other pressure switch does so on dropping below a lower limit (DPU) of DP. Expediently, the two pressure switches are pressure switches of the type allowing switching ranges to be set, one switching range being set downwardly from DPO and another switching range being set upwardly from DPU.

Advantageously, the actuating drives on the shut-off members TLV and EGV are equipped with external limit switches which are preferably embodied as proximity switches. Compared to internal limit switches, they offer the advantage of not needing to be readjusted after maintenance operations performed on the actuating drives.

At least if the control means used is a continuously operating controller, it is necessary to equip the shut-off members TLV and EGV each with an analogue position transmitter which issues a signal which is proportional to the instantaneous position of the shut-off member. If the control means is embodied with two pressure switches, then analogue position transmitters are not compulsory, but nevertheless advisable.

A further configuration of the device according to the invention provides for the shut-off members TLV and EGV each to be embodied as high-power shut-off flaps with a double block sealing system with discharge of scavenging steam to the safe process side, such as has for years formed part of the prior art and been known to a person skilled in the art. As a result of the introduction of steam, which acts as a blocking medium, into the double block sealing system, it is possible to dispense, when the shut-off member is closed, with the positioning of blanking plates, as accidental overflow of substances via untight portions of the shut-off member can be reliably avoided. The steam is introduced with control of the differential pressure, the difference between the pressures in the shut-off member and in the pipeline downstream of the shut-off member being the control variable.

The invention allows the switching-over between production mode and decoking mode of a cracking furnace to be carried out by fewer staff and with a much lower risk of misoperation than is possible in accordance with the prior art. A high degree of safety can also be attained without expensive check flaps and/or safety relief valves. In addition, it offers the possibility of arranging the two shut-off members TLV and EGV in such a way as to allow the pipework to be embodied in an optimized manner in terms of the method and at the same time cost-effectively.

The invention will be described hereinafter in greater detail with reference to an exemplary embodiment describing the most important process steps which ensue during the automatic switching of the shut-off members TLV and EGV of a cracking furnace when said furnace is switched over between production mode and decoking mode.

If the cracking furnace is switched over from production mode into decoking mode, TLV is first completely opened and EGV completely closed. The automatic switching process of the two shut-off valves TLV and EGV is triggered via an electrical start signal issued by an operator or the electronic controller of the cracking furnace.

If a continuously operating controller, such as for example an electric PID controller, is used to control the pressure loss across TLV, then said controller is activated in the following process step at a preset differential pressure target value DP. Afterwards, the shut-off member TLV begins to close at its normal displacement speed. On reaching a preset switch-over point, the displacement speed is significantly reduced to approx. 10% of the normal displacement speed. If the differential pressure DP, which rises over the course of the closing process of TLV, exceeds the target value DP target which is preset on the PID controller, the PID controller issues an actuating signal to the actuating drive of EGV, as a result of which EGV begins to open at a slow displacement speed. During the opening of EGV, the TLV continues to close. Depending on the extent and the sign of the control deviation calculated by the PID controller, the PID controller issues actuating signals for opening or closing to the actuating drive of EGV. As soon as TLV is completely closed, an externally attached limit switch issues a signal to deactivate the PID controller. After EGV is completely opened, the automatic switching process is ended. Thus, during the switching process, the two shut off members are actuated essentially simultaneously and are actuated in conjunction with one another.

If two differential pressure switches are used to control the pressure loss across TLV, the shut-off member TLV begins after the start of the automatic switching process to close at its normal displacement speed. On reaching a preset switch-over point, the displacement speed is significantly reduced to approx. 10% of the normal displacement speed. If the differential pressure DP, which rises over the course of the closing process, exceeds the upper limit DPO (for example 1.1 bar) set on one of the two differential pressure switches, the differential pressure switch issues to the actuating drive of EGV an actuating signal as a result of which EGV begins to open at a slow displacement speed. During the opening of EGV, the TLV continues to close. The actuating signal for opening EGV is issued until DP has dropped to a value which is less than DPO less a set first switching range (for example 60 mbar). As TLV continues to close, DP rises again. As soon as DP again exceeds the upper limit DPO, the differential pressure switch again issues an actuating signal to open EGV. Should DP drop below a lower limit DPU (for example 0.9 bar) set on the second differential pressure switch, this differential pressure switch issues to the actuating drive of EGV an actuating signal as a result of which EGV is displaced in the closure direction. The closing process is continued until DP has risen to a value which is greater than DPU plus a second switching range (for example 60 mbar) set on the second differential pressure switch. As soon as TLV is completely closed, EGV is completely opened without further interruption and the switching process ended. Thus, during the switching process, the two shut off members are actuated essentially simultaneously and are actuated in conjunction with one another.

If the cracking furnace is switched over from decoking mode to production mode, TLV is first completely closed and EGV completely opened. The automatic switching process of the two shut-off valves TLV and EGV is triggered via an electrical start signal issued by an operator or the electronic controller of the cracking furnace.

If a continuously operating controller, such as for example an electric PID controller, is used to control the pressure loss across TLV, then said controller is activated in the following process step at a preset differential pressure target value DP target. Afterwards, the shut-off member EGV begins to close at its normal displacement speed. On reaching a preset switch-over point, the displacement speed is significantly reduced to approx. 10% of the normal displacement speed. The differential pressure DP rises over the course of the closing process of EGV. If DP reaches a limit value, which is for example 50 mbar less than the target value DP target which is preset on the PID controller, TLV begins to open at a slow displacement speed. EGV remains closed for as long as DP is less than DP target. The limit value, which lies below DP target, is monitored by a differential pressure switch which, on dropping below the limit value, issues to the actuating drive of TLV a stop signal which is applied until DP exceeds the limit value again. Depending on the extent and the sign of the control deviation calculated by the PID controller, the PID controller issues actuating signals for opening or closing to the actuating drive of EGV. As soon as EGV is completely closed, an externally attached limit switch issues a signal to deactivate the PID controller. After TLV is completely closed, the automatic switching process is ended.

If two differential pressure switches are used to control the pressure loss across TLV, the shut-off member EGV begins to close at its normal displacement speed after the start of the automatic switching process. On reaching a preset switch-over point, the displacement speed is significantly reduced to approx. 10% of the normal displacement speed. If the differential pressure DP, which rises over the course of the closing process, exceeds the lower limit DPU (for example 0.9 bar) set at one of the two differential pressure switches, the differential pressure switch issues to the actuating drive of TLV an actuating signal as a result of which TLV begins to open at a slow displacement speed. The actuating signal for closing EGV is issued until DP has risen to a value which is greater than DPU plus a set first switching range (for example 60 mbar). As TLV continues to open, DP drops again. As soon as DP again drops below the lower limit DPU, the differential pressure switch again issues an actuating signal for closing EGV. Should DP exceed an upper limit DPO (for example 1.1 bar) which is set on the first differential pressure switch, this differential pressure switch issues to the actuating drive of EGV an actuating signal as a result of which EGV is opened. The opening is continued until DP has dropped to a value which is less than DPO less a set second switching range (for example 60 mbar). As soon as EGV is completely closed, TLV is completely opened without further interruption and the switching process ended.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding German application No. 10 2008 010 654.2, filed Feb. 22, 2008.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A method for switching over a cracking furnace between production mode and decoking mode, wherein said cracking furnace comprises a transfer line which comprises a first shut-off member (TLV) equipped with a first actuating drive, and said cracking furnace comprises a decoking line, branching off of said transfer line, and which comprise a second shut-off member (EGV) equipped with a second actuating drive, said method comprising:
during the switching over, continuously measuring and monitoring the differential pressure DP across the shut-off member TLV,
displacing shut-off members TLV and EGV out in an automated manner, wherein TLV is moved monotonously between its end positions, while the second actuating drive is triggered by the actuating signal of a control means and EGV is as a result actuated in such a way that, during the switching over, the differential pressure DP is approximated to a predefined target value (DP target).

2. A method according to claim 1, wherein the measured value for DP is converted into an electrical signal and supplied as an actual value (DP actual) to said control means, and said control means issues a continuous electrical actuating signal to the actuating drive of EGV on the basis of comparison of DP actual with DP target.

3. A method according to claim 1, wherein DP is monitored and controlled by means of two pressure switches, wherein one pressure switch issues a discrete electrical actuating signal to the actuating drive of EGV on DP exceeding an upper limit (DPO), and the other pressure switch issues a discrete electrical actuating signal to the actuating drive of EGV on DP dropping below a lower limit (DPU).

4. A method according to claim 1, wherein said two shut-off members, TLV and EGV, are each displaced at at least two different speeds, wherein the extent of the displacement speed for each shut-off member is dependent on the instantaneous position of the shut-off member.

5. A method according to claim 2, wherein said two shut-off members, TLV and EGV, are each displaced at at least two different speeds, wherein the extent of the displacement speed for each shut-off member is dependent on the instantaneous position of the shut-off member.

6. A method according to claim 3, wherein said two shut-off members, TLV and EGV, are each displaced at at least two different speeds, wherein the extent of the displacement speed for each shut-off member is dependent on the instantaneous position of the shut-off member.

7. A method according to claim 1, wherein, during said switching over, said cracking furnace is switched from production mode to decoking mode.

8. A method according to claim 1, wherein, during said switching over, said cracking furnace is switched from decoking mode to production mode.

9. A system for switching over a cracking furnace between production mode and decoking mode, comprising:
a first shut-off member (TLV) arranged in a transfer line connected to a cracking furnace, and a first actuating drive connected to said first shut-off member via which said first shut-off member can be displaced,
a second shut-off member (EGV) arranged in a decoking line, which braches off of said transfer line, and a second actuating drive connected to said second shut-off member via which said second shut-off member can be displaced,
a differential pressure measuring means which can be used continuously to measure and monitor the differential pressure DP across shut-off member TLV, and
control means for actuating said two shut-off members, wherein said control means can cause displacement of shut-off member EGV in such a way that during the switching over DP is approximated to a predefined target value (DP target), while TLV is moved monotonously between its end positions.

10. A system according to claim 9, wherein said control means is an electric PID controller to which a measured value for DP, which has been converted into an electrical signal, can be supplied as an actual value (DP actual), and which issues a continuous electrical actuating signal to the actuating drive of EGV on the basis of comparison of DP actual with DP target.

11. A system according to claim 9, wherein said control means comprises two pressure switches, wherein one pressure switch issues a discrete electrical actuating signal to the actuating drive of EGV on DP exceeding an upper limit (DPO), and the other pressure switch issues a discrete electrical actuating signal to the actuating drive of EGV on DP dropping below a lower limit (DPU).

12. A system according to claim 9, wherein said two shut-off members TLV and EGV are each equipped with limit switches and analogue position transmitters.

13. A system according to claim 10, wherein said two shut-off members TLV and EGV are each equipped with limit switches and analogue position transmitters.

14. A system according to claim 11, wherein said two shut-off members TLV and EGV are each equipped with limit switches and analogue position transmitters.
